(19) United States
(12) Patent Application Publication
(10) Pub. No.: US 2015/0066597 A1
(43) Pub. Date: Mar. 5, 2015

(54) PROFIT-BASED LAYOUT DETERMINATION FOR WEBPAGE IMPLEMENTATION

(71) Applicant: Kobo Incorporated, Toronto (CA)

(72) Inventor: Inmar-Ella GIVONI, Toronto (CA)

(73) Assignee: Kobo Incorporated, Toronto (CA)

(21) Appl. No.: 14/019,311

(22) Filed: Sep. 5, 2013

(51) Int. Cl. G06Q 10/06

(52) U.S. Cl. CPC G06Q 10/0637
USPC 705/7.36

(57) ABSTRACT

Systems and methods for automatic generation and efficient exploration of a large number of webpage layouts to discover a layout with superior empirical performance. A set of variants are displayed to visitors in accordance with a display probability distribution. Data related to visitors' interactions to the variants are collected and processed to evaluate their respective profit-related performances. The display probability distribution may be dynamically adjusted based on the profit-based evaluation. A profit brought by a webpage layout may be ascribed to a number of revenue sources. These difference revenues may be tracked and summed together to yield a profit assessment for a layout variant. Profit performance of a layout variant may be calculated using a Gaussian with NΓ⁻¹ prior model, or a Gaussian-Dirac delta mixture mode.

### CROSSREFERENCES

The present disclosure is related to: the co-pending patent application titled “AUTOMATIC GENERATION OF A WEBPAGE LAYOUT WITH HIGH EMPIRICAL PERFORMANCE,” filed on Jun. 27, 2013 and Ser. No. 13/929, 675, which is herein incorporated by reference for all purposes.

### TECHNICAL FIELD

The present disclosure relates generally to the field of webpage generation, and, more specifically, to the field of automatic generation of webpages related to e-commerce.

### BACKGROUND

It is well recognized that different placements of information on a webpage may attract different levels of attention from an average visitor, or viewer. For example, in the context of e-commerce marketing, a product advertisement may be more likely to be viewed or clicked if the advertisement is placed at the top center, rather than at a corner of the webpage, etc. Visitors' attention to an advertised product is renownedly correlated to their propensity to enter into a business transaction for the product. In accordance with the correlation, the marketing performance of a webpage layout can be directly evaluated by the statistics of visitor interactions with the webpage. Conventionally, the number of purchases made after viewing a webpage divided by the number of views, or the “conversion rate”, is typically used as an indication of the users' interest in the advertised products and therefore their tendency of purchasing the products. However, a conversion rate is usually an indirect indicator of business profit ascribed to a webpage layout, and thus market performance derived from a conversion rate may not be reliable and effective.

A webpage may typically include several on-screen applications, or widgets. Given a number of available widgets, numerous webpage layouts can be yielded through various selections and placements of the widgets and other information. Conventionally, a webpage layout is generated manually and typically relies on no more than a few web designers' subjective judgments and personal tastes. Since manually creating and amending webpage layouts involve laborious and time consuming processes, an attempt to explore a large number of layouts to obtain an effective layout by such manual means is likely unrealistic.

### SUMMARY OF THE INVENTION

Therefore, it would be advantageous to provide a computer implemented mechanism for automatic generation and efficient empirical exploration of a large number of webpage layouts that will discover one or more optimal layouts with high profit rates. Accordingly, embodiments of the present disclosure employ a computer implemented method of automatically generating a set of layout variants from a pre-existing webpage layout based on predefined criteria, and exploring the set of variants by virtue of dynamically adjusting display probability distribution in accordance with the respective profit rates of the variants. Effectively, the e-commerce effectiveness of the variants can be used to automatically grade each variant. The score of a variant may control the probability of subsequent presentation of the variant to a website visitor. Eventually, very effective webpage layouts are determined.

The pre-existing webpage layout may be an expert created layout and may include a number of widgets arranged in a pattern. A number of permitted modification rules regarding the placement and selection of widgets may be predefined to guide the generation and adjustment of the set of variants. The set of variants are displayed to visitors based on a display probability distribution. Data related to visitors' interactions to the variants are automatically collected and processed to evaluate or score or grade their respective profit rate(s). The display probability distribution may be dynamically adjusted based on the evaluation. Poorly performing variants can be discarded and promising variants may be added for exploration. As a result, an optimal or effective layout variant can be automatically determined in this fashion.

A profit brought by a webpage layout may be ascribed to a number of revenue sources, e.g., a number of commodity categories. These difference revenues may be tracked and summed together to yield a profit assessment for a layout variant. Profit performance of a layout variant may be calculated using a Gaussian with a Normal inverse-Gamma prior model, or a Gaussian-Dirac delta mixture mode.

In one embodiment of the present disclosure, a computer implemented method of automatically determining a webpage layout comprises: (1) accessing a set of test webpage layouts; (2) selecting for display the set of test webpage layouts to visitors to a website in accordance with a display probability distribution, wherein each test webpage layout is assigned with a respective display probability value; (3) evaluating the set of test webpage layouts based on profit associated with purchase activities based on commodities presented in the set of test webpage layouts; (4) adjusting the display probability distribution based on the evaluating; (5) repeating the selecting and the evaluating; and (5) selecting a resultant webpage layout from the test webpage layouts based on the evaluation. The evaluation may comprise determining expected profit rates of the set of test webpage layouts based on a determination that a profit rate is normally distributed per widget category. The display probability distribution may be adjusted based on a distribution of the expected profit rates over the set of test webpage layouts. The hyper-parameters of a respective normal distribution may be updated based on observed profit values associated with a respective test webpage layout. An expected profit rate of the respective test webpage layout may correspond to a mean of the observed profit values. The observed profit values may be computed based on view-events resulting in purchases. The expected profit rate of the respective test webpage layout may be derived by a weighted integration of K components of profit rates in accordance with a multinomial distribution, wherein K is an integer and represents a number of commodity categories presented through the respective test webpage layout. Each of the K components may correspond to a respective Gaussian distribution. The expected profit rate may also be determined based on a conversion rate and observed profit values related to the respective test webpage layout. The expected profit rate may be computed by a combination of a zero-profit component and a normally distributed component.

In another embodiment of present disclosure, a non-transitory computer-readable storage medium embodying instructions that, when executed by a processing device, cause the processing device to perform a method of determining a profit rate of a webpage layout, the method comprising: (1) selecting for displaying the webpage layout to visitors to a website with content comprising commodities in N view events, wherein N is an integer; (2) determining a conversion rate r of the webpage layout; (2) determining a respective profit mᵢ resulted from each view-event, wherein i=1, 2, . . . , N; (3) deriving a profit rate distribution p from a zero-profit component and a normally distributed component, wherein each component comprises a respective probability value related to the conversion rate, wherein the zero-profit component corresponds to view-events resulting in no purchases, and wherein the normally distributed component corresponds to view events resulting in purchases; and (4) deriving a profit rate of the webpage layout based on the profit rate distribution.

In another embodiment of present disclosure, a system comprises: a processor; a network circuit; and a memory coupled to the processor and comprising instructions that, when executed by the processor, automatically determine a webpage layout for a website, the method comprising: (1) accessing a set of test layouts; (2) selecting for display the set of test layouts to visitors to the website in accordance with a display probability distribution, wherein each test layout is assigned with a respective display probability value; (3) evaluating the set of test layouts based on profit associated with commodities presented in the set of test layouts; (4) adjusting the display probability distribution based on the evaluating; (5) repeating the displaying and the evaluating; and (6) selecting a resultant layout from the test layouts based on the evaluating for subsequent displays.

This summary contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

Embodiments of the present invention will be better understood from a reading of the following detailed description, taken in conjunction with the accompanying drawing figures in which like reference characters designate like elements and in which:

FIG. 1A illustrates an exemplary webpage layout including a plurality of widgets placed in respective page locations in accordance with an embodiment of the present disclosure.

FIG. 1B illustrates an exemplary layout variant that can be automatically generated by swapping locations of two widgets and in FIG. 1A in accordance with an embodiment of the present disclosure.

FIG. 1C illustrates an exemplary layout variant that is automatically generated by substituting a widget in FIG. 1A in accordance with an embodiment of the present disclosure.

FIG. 2 is a flow chart illustrates an exemplary computer implemented method of determining a resultant webpage layout by using dynamically-adjusting parallel tests to explore a set of layout variants based on user interactions related thereto in accordance with an embodiment of the present disclosure.

FIG. 3 is a flow chart illustrating an exemplary method of generating display probability distribution for the L layout variants in accordance with an embodiment of the present disclosure.

FIG. 4 is a flow chart illustrating an exemplary method of computing profit rates of K categories of a respective layout variant in accordance with an embodiment of the present disclosure.

FIG. 5A illustrates a Beta-Bernoulli model used for calculating a conversion rate that can be used to derive a display distribution in accordance with an embodiment of the present disclosure.

FIG. 5B illustrates a Gaussian-Dirac delta mixture model used for calculating the display distribution in accordance with an embodiment of the present disclosure.

FIG. 5C illustrates an exemplary category-specific Gaussian-Dirac delta model wherein different mixture components in the model correspond to different product categories in accordance with an embodiment of the present disclosure.

FIG. 6 is a flow chart illustrating an exemplary generative process underlining the purchase observations in which underlying unknown parameters can be inferred in accordance with an embodiment of the present disclosure . . . .

FIG. 7 is a data plot illustrating empirical data that supports the Gaussian mixture model assumption that can be used in accordance with an embodiment of the present disclosure.

FIG. 8 is a block diagram illustrating an exemplary computing system including an automatic webpage layout generator in accordance with an embodiment of the present disclosure.

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### Notation and Nomenclature:

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or display devices. When a component appears in several embodiments, the use of the same reference numeral signifies that the component is the same component as illustrated in the original embodiment.

### Profit-Based Layout Determination for Webpage Implementation

Overall, embodiments of the present disclosure employ a profit-based computer implemented methodology to automatically evaluate and explore market performance of webpage layouts. In some embodiments, the evaluation and exploration process can include an A/B type testing scheme and an automatic loop process of showing a selection of layout variants in a probability distribution, assessing the relative performances of the set of variants based on their profit earning potentials, and dynamically adjusting the set of variants and respective display distribution probabilities by using the assessment results as the feedback. More explicitly, a set of variants are generated and presented to visitors in respective proportions or distribution probabilities. The respective impacts of the variants on visitors are assessed and compared based on profit rate data collected from visitor interactions with the variants. The assessment results are then incorporated to modify the set of variants, such as removing a badly performing one and adding a promising one, and to adjust the distribution probabilities for instance. The modified set of variants are then displayed in the respective adjusted distribution probabilities, and assessed again. Eventually one or more variants with superior profit rates can be advantageously determined empirically and automatically. Presented herein include exemplary models to compute profit rates and the resulted display probability distributions. However, the present disclosure is not limited to any specific mathematic model used to calculate profit rates related to webpage layouts.

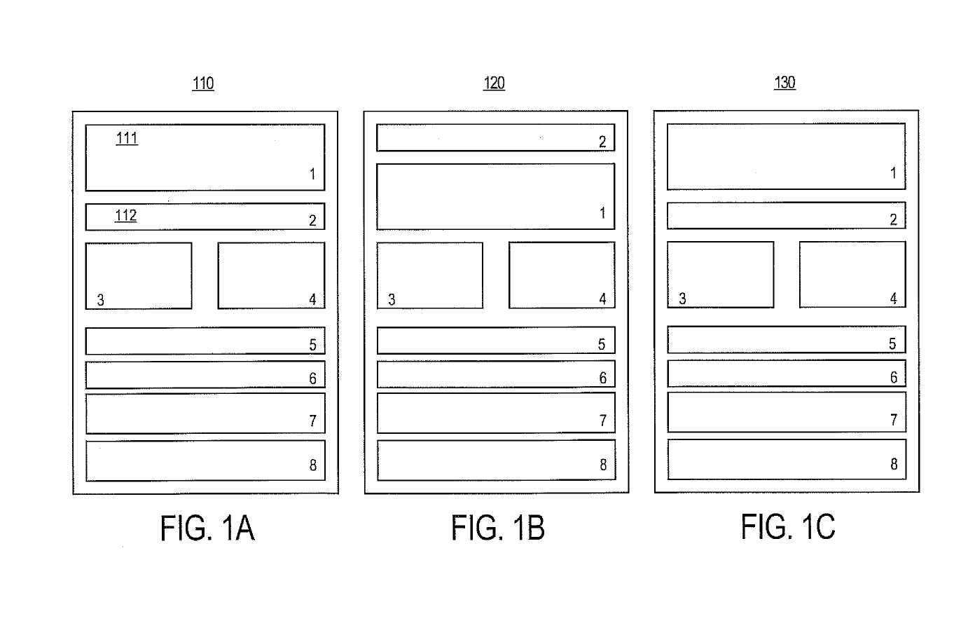

FIG. 1A illustrates an exemplary webpage layout 110 including a plurality of widgets placed in respective page locations in accordance with an embodiment of the present disclosure. The exemplary webpage layout 110 is partitioned into 8 slots for instance that can be populated from a pool of widgets and other information. For example, for an on-line book store, the pool of widgets may include a search bar, several lists of merchandise items, several recommendation lists, several marketing images, a top 50 merchandise list, top 50 lists in category of merchandise, e.g. fiction, romance, and business, and etc. For instance, the several lists of merchandise items may include lists of hot and new, popular pick, and new releases, NY Times list, Globe and Mail list, and so on. The webpage layout 110 may be generated by expert-created or automatically generated in accordance with an embodiment of the present disclosure. Almost any widget type or subject matter presentation can be used, etc.

In one embodiment, a layout variant refers to a particular choice of which widgets to be placed in which slots. Given a webpage template having S slots and W eligible widgets, there may be up to

$$\frac{W !}{( W - S ) !}$$

possible variants. For instance, if S=8 and W=12, there are almost 20 million possible variants in total. Exhaustive testing can be a feasible option for smaller S and W in some embodiments, but may not be efficient for large S and W scenarios. Thus, in some other embodiments, a set of predefined constraints and/or allowable variations can be imposed to confine the search to only some reasonably promising variants. For example, a constraint can specify that every variant should include the search bar and the recommendation widgets, and that the marketing image widget should not be placed at the top slot.

Starting with an initial webpage layout created by an expert, e.g., webpage designer, it can be reasonably presumed that an optimal variant outcome form the empirical search process may not be substantially different from the initial layout. In some embodiments, the set of variants used for a search process can be generated by incrementally modifying the initial webpage layout. Such modifications may include swapping locations of any two widgets and substituting a currently used widget with a currently unused widget.

For instance, the webpage layout 110 can be used as a baseline layout to spawn a set of variants for empirical exploration in accordance with an embodiment of the present disclosure. FIG. 1B illustrates an exemplary layout variant 220 that can be automatically generated by swapping locations of two widgets 111 and 112 in FIG. 1A in accordance with an embodiment of the present disclosure. By swapping locations of any two widgets in FIG. 1A, 28

$$( = \frac{S \times ( S - 1 )}{2} )$$

variants can be derived. FIG. 1C illustrates an exemplary layout variant 130 that is automatically generated by substituting a widget 111 in FIG. 1A in accordance with an embodiment of the present disclosure. By substituting a widget currently used in the initial layout 110 with a currently unused widget, 32 (=S×(W−S)) variants can be automatically derived. Then the 60 variants can be published on the website for empirical exploration. As demonstrated by the example, starting with a set of variants derived by incrementally automatically modifying of the initial webpage layout, as well as imposing constraints and prescribed rules in searching for new variants to add for exploration, significantly reduces the number of variants for exploration and effectively confine the search scope to the most promising layout design, advantageously expedites converging of the search result.

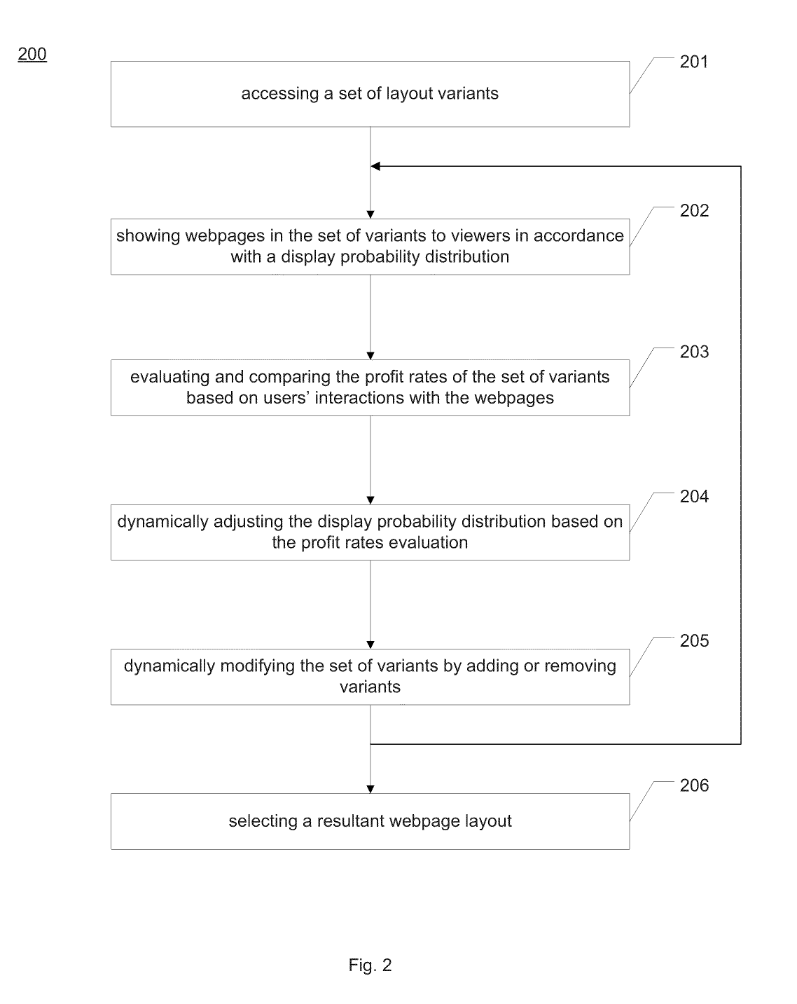

FIG. 2 is a flow chart that illustrates an exemplary computer implemented method 200 of determining a resultant webpage layout by using dynamically-adjusting parallel tests to explore a set of layout variants based on user interactions related thereto in accordance with an embodiment of the present disclosure. At 201, a set of layout variants are accessed. In some embodiments, the set of variants may be generated automatically by modifying a reasonably good baseline layout based on predefined constraints and/or allowable modification moves, as described with reference to FIG. 1A-FIG. 1C. However, the present disclosure is not limited to any particular process or prescribed rules of automatically generating a set of variants.

At 202, the set of layout variants are displayed to visitors of the website in accordance with a display probability distribution. The display probability distribution may be form uniform distribution initially, absent of factors indicating any preference. User interactions with the webpages associated with these variants are collected, such as clicks, views, and purchases.

At 203, the performances of the set of variants are evaluated and compared based on statistical data of profit data collected from visitor interactions with the webpages associated with the variants. As will be appreciated by those skilled in the art, the present disclosure can be applied in any suitable type of webpages used for any purposes. The webpages may contain both profit-oriented and non-profit oriented contents and may be hosted by sellers, manufactures, marketers, retailers, licensors, renters, educators, service providers, and etc. The webpages may be devoted to businesses involving e-commerce or traditional commerce and contain information regarding any type of commodities, such as books, clothes, furniture, food, toys, devices, appliances, health products, tickets, services, and human resources, to name a few.

At 204, the display probability distribution can be adjusted based on the evaluation for subsequent display of the set of variants. In some embodiments, the probability distribution may be adapted to a weighted distribution wherein the distribution values assigned to each variant are maintained substantially proportional to the respective accumulated scores resulted from the process of 203.

At 205, based on the performance evaluation results or scores, the set of variants can be dynamically updated by adding new variants or removing variants with inferior performance for subsequent exploration. The updated set of variants are then displayed in accordance with the adjusted probability distribution, and evaluated based on new or accumulated user interactions again. In some embodiments, when low performing variants are dropped, they can be replaced with new ones and the iteration process can continue.

The foregoing 203-205 are repeated until one or more resultant webpage layouts are determined at 206, e.g. a resultant webpage with the best expected profit rate or with the largest display probability, or any other suitable measure that can be appreciated by those with ordinary skill in the art. In some embodiments, the resultant webpage layout can be used for all the subsequent displays.

As will be appreciated by those with ordinary skill in the art, the present disclosure is not limited by any particular method of assessing profit earning performance with respect to the layouts. The profit earning related metric used for webpage layout evaluation according to the present disclosure can be based on various suitable financial and/or mathematical theories and models. The evaluation may be based on actual data, estimated data, or predicted data, and so on. In some embodiments, different widgets or different categories of products can be evaluated using different metrics. In some embodiments, the evaluation results with respect to the set of variants can be ranked in the form of scores.

Generally speaking, an objective for the evaluation process is to use the profit performance to determine the respective display probabilities in which selected webpage layouts are displayed. For purposes of illustration, assuming a set of test layouts are indexed by l=1, 2, . . . , L, the total per-layout impression count are represented as N^{l}, and the per-layout profits are represented as (m₁^{l}, m₂^{l}, . . . , m_{N}_{ₗ}^{l}). Each profit data can be associated with a category (book, advertisement, merchandise, etc.), resulting in a per-layout category observation (c₁^{l}, c₂^{l}, . . . , c_{N}_{ₗ}^{l}), where cᵢ^{l}=k, kε{1, . . . , K} for K categories. In some embodiments, each profit value mᵢ^{l} can be generated from a layout-specific profit-per-view distribution p^{l}. The p^{l} can then be used to determine which layout to show. For example, the more profitable a layout, the more likely it is to be displayed. The distribution over layouts may be computed based on the p^{l}'s.

As will be described in greater detail below, in some embodiments, a Bayesian approach may be adopted in determining the p^{l}, where parameters of the p^{l} themselves can be uncertain and may come from some parametric distribution, e.g., the prior. Typically, conjugate priors are used so that new observations simply result in updates of the hyper-parameters. The updated hyper-parameters can be used for sampling the parameters for p^{l}.

In some alternative embodiments, a Beta-Binomial model can be adopted, wherein p^{l} may be equal to the conversion rate, such as Beta distributed. Determining a layout to show may include sampling the two parameters of the model, sampling values from each p^{l} using the sampled parameters, and displaying the one with the highest value. Alternatively, the determination process may include sampling parameters, integrating the observations, and using some sufficient statistic such as expected mean where the distribution with the largest one is selected. For example, creating a multinomial distribution representing what proportion of users should be viewing which layouts can be similarly achieved by sampling the parameters/observations/statistics multiple times, determining the best layout for each sample and using the proportion for which a layout is chose as the best to determine the distribution over layout.

Distributions over profit-values can be used to model profit rates, e.g, profit-per-view. In some embodiments, a Gaussian with a Normal inverse-Gamma (NΓ⁻¹) prior model can be employed in which it can be assumed that profit rates are normally distributed. Each layout may be associated with a different unknown underlying normal distribution p^{l}. For example, the parameters of the normal distribution can be distributed with the normal inverse gamma, e.g., representable as (μ, ρ)˜NΓ⁻¹(m, s, v, κ), which is the conjugate prior for the normal distribution. The four hyper-parameters, collectively referred to as Θ herein, can be updated according to the values of the profit observations.

In some embodiments, each layout can be associated with a set of K distributions, one per category, to account for different ranges and spreads of profits arising from different categories. A multinomial distribution over categories can be calculated or estimated. The resulting observations can be regarded as coming from a mixture of Gaussians. Since the associated category of the observations can be known, each Gaussian and the mixture weights can be directly estimated. The conjugate prior for a multinomial may be a Dirichlet distribution.

In some embodiments that utilize simple Gaussian functions, each sample of p^{l} has two parameters. Selection of a layout to display by comparing samples can be determined by analytically computing P (A>B) in a two-layout case. For a multiple-layout case, mean values of expected profit-per-view of the samples can be used for the comparison and the selection of the layout for display.

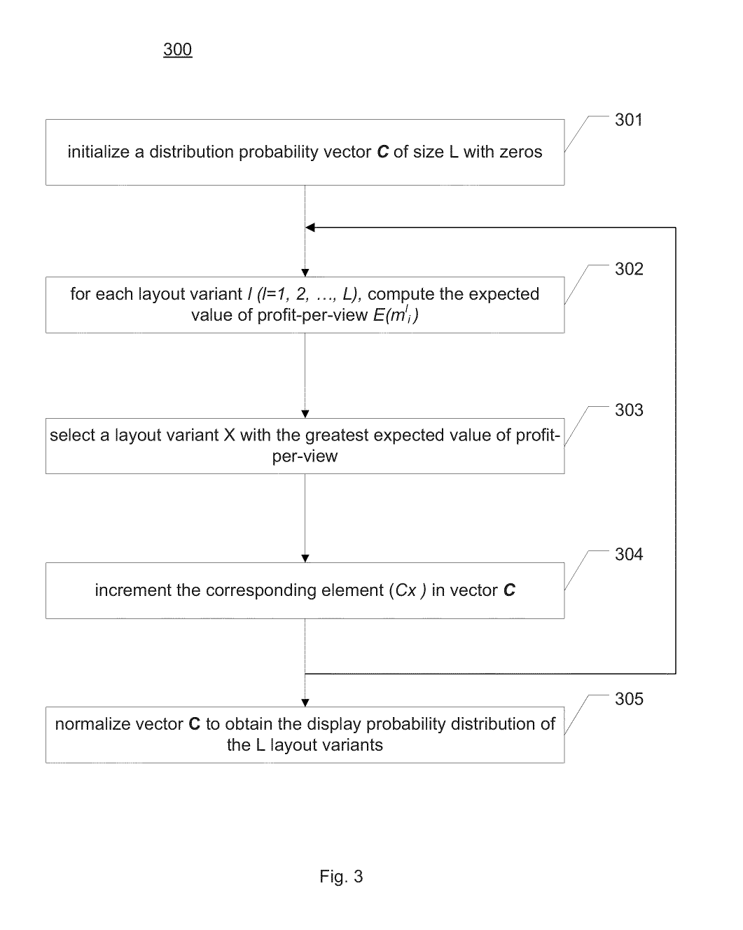

FIG. 3 is a flow chart illustrating an exemplary method 300 of generating a display probability distribution for the L layout variants in accordance with an embodiment of the present disclosure. Method 300 can be implemented as a computer program. Method 300 is similar to process 203 in FIG. 2. At 301, a distribution probability vector C of size L is initialized with zeros. At 302, for each layout variant (l=1, 2, . . . , L), the expected value of profit-per-view is computed. As will be appreciated by those skilled in the art, any other suitable metric related to observed profit data and indicative of profit earning potential of a webpage layout can be used to implement method 300. At 303, a layout variant X is selected with the greatest mean of expected value of profit-per-view. At 304, the corresponding element Cᵢ in vector C is incremented. The foregoing 302 and 304 are then repeated for each layout variant. At 305, the vector can be normalized and used as the display probability distribution of the L layout variants.

For the case of different categories, expected value of the profit-per-view of can be integrated out after the π, {μₖ, ρₖ} are sampled, e.g.,

$$E ( {m}_{i} \vert \{ {μ}_{k} , {ρ}_{k} \} {κ}_{k = 1} , π ) = {\sum }_{k} {π}_{k} {μ}_{k} ,$$

where π is a vector of length L.

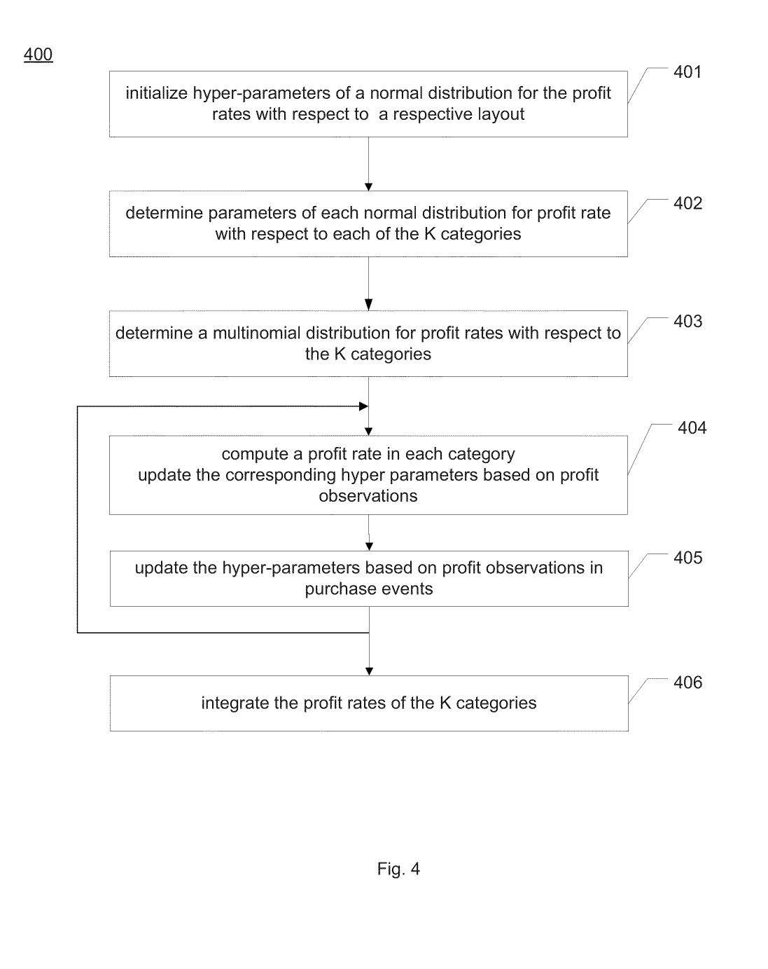

FIG. 4 is a flow chart illustrating an exemplary method 400 of computing profit rates of K categories of a respective layout variant in accordance with an embodiment of the present disclosure. Method 400 can be implemented as a computer program. Method 400 is similar to step 302 in FIG. 3. At 401, the hyper-parameters of a normal distribution of the profit rate with respect to a respective layout are initialized. The parameters of a normal distribution for each profit rate category are determined at 402. A multinomial distribution is then determined with respect to the K categories at 403. The profit rate is computed with respect to a respective category at 404. The hyper-parameters are updated based on the profit observations in purchase events at 405. Steps 404-405 are repeated for each category. At 406 the profit rates are then integrated over the K categories to derive the profit rate for the respective layout.

A Gaussian-Dirac delta mixture model can be used to determine the distributions over profit-values, which is a mixture of a zero-profit component corresponding to the non-purchase view-events and a normal distributed component corresponding to non-zero purchase view-events.

In some embodiments, purchase-per-view can be computed and used to determine the display distribution. For example, the purchase-per-view profit of every purchase can be expressed as a combination of is zero-purchase with probability 1−r, and some number from a normal distribution centered at μ with precision ρ, with probability r. e.g., if dropping l for brevity,

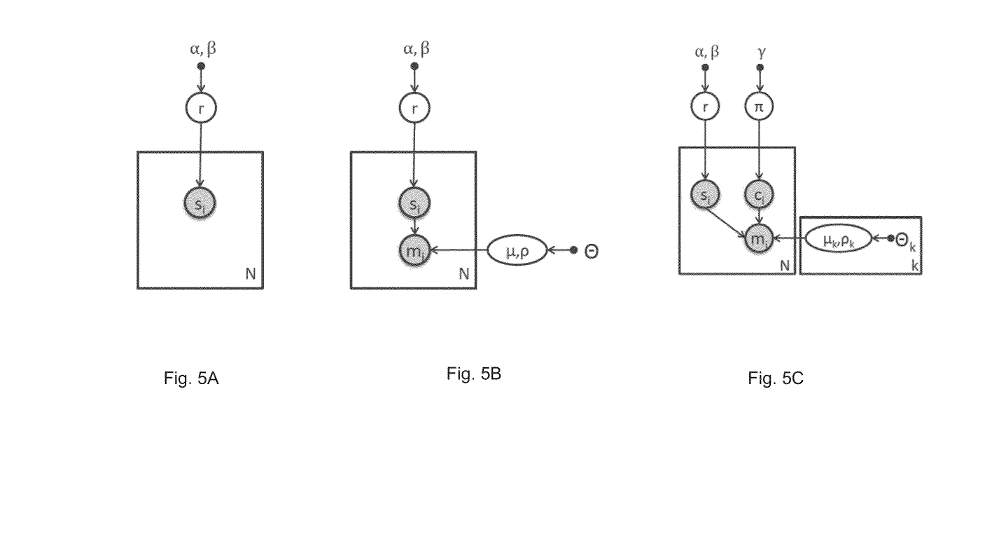

p(mᵢ)=r·N(mᵢ|μ,ρ)+(1−r)δ(mᵢ),

where rε[0,1]. This approach can be regarded as an extension of a Beta-Binomial model in which a purchase amount is sampled for each layout after the standard conversion rate has been sampled. FIG. 5A illustrates a Beta-Bernoulli model used for calculating a conversion rate that can be used to derive a display distribution in accordance with an embodiment of the present disclosure. For every view-per-layout, a variable sᵢ^{l} can be sampled from the conversion rate which is calculated based on a and/to determine whether or not to purchase, where purchase/non-purchase events were the observations.

FIG. 5B illustrates a Gaussian-Dirac delta mixture model used for calculating the display distribution in accordance with an embodiment of the present disclosure. In addition to the conversion rate shown in FIG. 5A, another observation, mᵢ^{l}, is sampled from a normal distribution based on μ and ρ if sᵢ^{l}=1, and is deterministically 0 if sᵢ^{l}=0.

Given sampled r, μ and ρ using the updated hyper-parameters, the expected value of the profit-per-view can be computed by integrating out sᵢ^{l} to obtain

E(mᵢ|r,μ,ρ)=μ·r.

In the category specific Gaussian-Dirac delta mixture model, different distributions can be used for different categories. In an exemplary process, for each view event, the hidden variables can be generated by sampling a conversion rate r by virtue of Bernoulli from Beta, sampling the category weights π which is a K dimensional multinomial from a Dirichlet distribution function, and sampling the per-category profit parameters e.g., μₖ, ρₖ from normal inverse gammas. FIG. 5C illustrates an exemplary category specific Gaussian-Dirac delta model where different mixture components correspond to different product categories in accordance with an embodiment of the present disclosure. Each category-specific profit distribution can have its own hyper-parameters Θₖ. The observations are then generated by sampling a purchase/non-purchase value for the variable sᵢ based on r. A category cᵢ can be sampled based on π. Then the profit can be derived. For example, if sᵢ^{l}=0, mᵢ is set to 0; otherwise, a profit value mᵢ is sampled from the category's profit model, e.g., based on a Gaussian function with μ_{c}_{ᵢ}, ρ_{c}_{ᵢ}.

The observations are therefore distributed as a mixture of a Gaussian mixture and a Dirac delta. After the categories are observed, each category's parameters can be estimated separately.

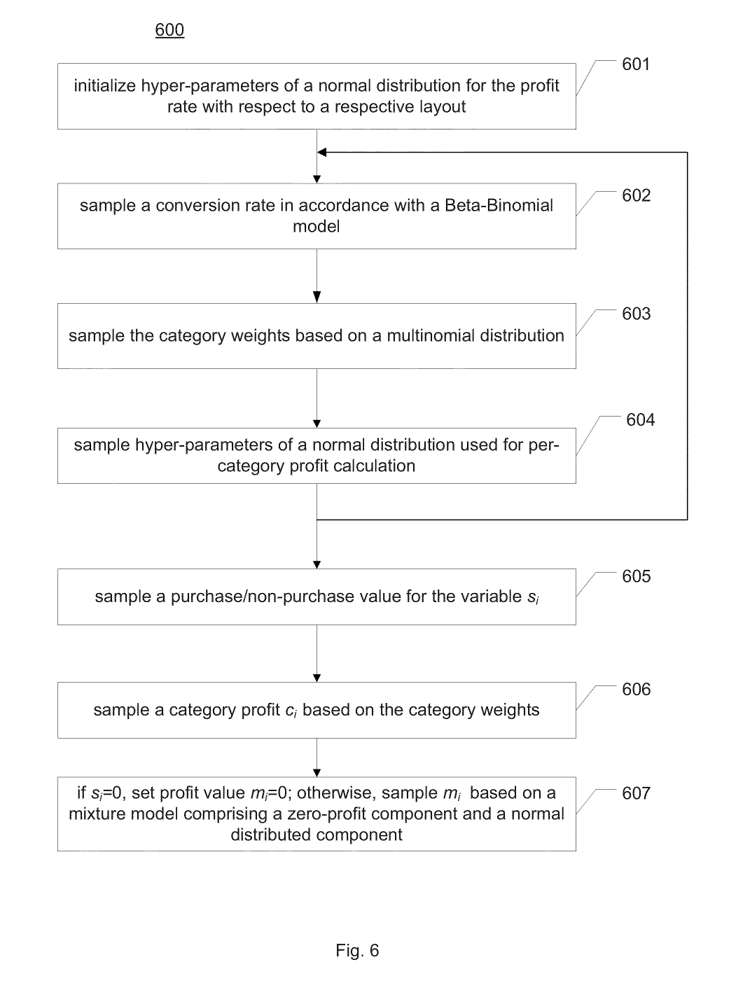

FIG. 6 is a flow chart illustrating an exemplary generative process underlining the purchase observations, in which underlying unknown parameters can be inferred in accordance with an embodiment of the present disclosure. The flow chart illustrates the generative process assumed to explain how the observed user purchase data is generated. With that assumption, a mathematical model is described that, given user purchases, infers underlying unknown quantities that relate to the profitability of a particular page profit rate. At 601, for a respective layout, the hyper-parameters of a normal distribution of the profit rate are initialized at 601. The conversion rate is sampled in accordance with a Beta-Binomial model at 602. At 603, the category weights are sampled based on a multinomial distribution. At 604, for each profit category, the hyper-parameters of a normal distribution is sampled. At 605, a purchase/non-purchase value is sampled for the variable sᵢ^{l}. At 606, a category profit cᵢ is sampled based on the category weights. At 607, if sᵢ^{l}=0, mᵢ is set to 0; otherwise, a profit value mᵢ is sampled from the category's profit model, e.g., based on a Gaussian function with μ_{c}_{ᵢ}, ρ_{c}_{ᵢ}.

Table 1 lists exemplary equations for updating the hyper-parameters based on observations related to profit rate in accordance with an embodiment of the present disclosure. In some embodiments, the order of update may be predetermined. For instance, the last parameter sₖ can be updated using the newly calculated κ′ₖ and m′ₖ.

TABLE 1
Model:

| | |
|---|---|
| r ~ Beta(α, β) | sᵢ ~ Ber(r) |
| π ~ Dir([γ₁, . . . γ_{K}]) | cᵢ ~ Mult(π) |

```
                      (μₖ, ρₖ) ~ NΓ⁻¹ (mₖ, sₖ, νₖ, κₖ)
                    mᵢ|sᵢ = 0 ~ δ(mᵢ)
              mᵢ|sᵢ = 0, cᵢ = k ~ [symbol]  (mᵢ|μₖ, ρₖ)
Sufficient statistics based on observations sᵢ, cᵢ, mᵢ:
  N − The total number of views
  $S = {\sum }_{i} {s}_{i} = 1 - The total number of purchases$
  ${S}_{k} = {\sum }_{i} [ {c}_{i} = k ] [ {s}_{i} = 1 ] - the total number of purchases per category$
  ${P}_{k} = {\sum }_{i} [ {c}_{i} = k ] \cdot {m}_{i} - the sum of all profit per category$
  ${P}_{k}^{2} = {\sum }_{i} [ {c}_{i} = k ] \cdot {m}_{i}^{2} - the sum of all squared profits per category$
Hyper-parameter updates:
$\begin{matrix}α := α + S \\ β := β + ( N - S ) \\ {γ}_{k} := {γ}_{k} + {S}_{k} \\ {κ}_{k} := {κ}_{k} + {S}_{k} \\ {ν}_{k} := {ν}_{k} + {S}_{k} \\ {m}_{k} := \frac{{κ}_{k} {m}_{k} + {P}_{k}}{{κ}_{k} + {S}_{k}} \\ {s}_{k} := {s}_{k} + {P}_{k}^{2} + {κ}_{k} {m}_{k}^{2} - {κ}_{k}^{′} {{m}^{′}}_{k}^{2}\end{matrix}$
```

Table 2 lists exemplary initial values for hyper-parameters for profit rate calculation in accordance with an embodiment of the present disclosure. The initial values of α and β can be selected such that the mean of the Beta distribution

$$\frac{α}{α + β}$$

is roughly at the conversion rate that is between 0 and 1, and the sum can reflect the number of pseudo observations, or the fake sessions. The number of pseudo observations may affect the difficulty for the data to overcome the prior, and on obtaining meaningful prior and computational results.

TABLE 2

α = 10K
β = 90K
γ = 1
mₖ = 12.15
sₖ = 370.370
vₖ = 100K
Nₖ = 100K

The initial value of γ can be a fixed number, e.g., 1 for a one-product case (k=1, or k=0 if zero-based is used). In some embodiments, more than one product are modeled, the data statistic can be used for setting priors, where probabilities are calculated based on category distribution, and counts based on per day counts. The initial value of mₖ can be the prior estimate of the mean of the profit. For example, it can be derived by running a query on dashboard-purchases for the last month.

The initial value of κ represents the total number of pseudo observations. For example, it can be selected such that the prior can be overwhelmed after one day of data collection if the true mean is different than mₖ. The initial value of v is similar to κ and represents the total number of pseudo observations.

The initial value sₖ represents the prior estimate controlling of the precision of the profits

$$( e . g . , ρ = \frac{1}{{σ}^{2}} ) ,$$

where

$$E ( ρ ) = \frac{μ}{s} = E ( \frac{1}{{σ}^{2}} ) = \frac{1}{E ( {σ}^{2}} ) .$$

E(σ²) can be estimated by computing the variance of the data.

Given the updated form of the hyper-parameters, values of π, r, {μₖ, ρₖ} from the posterior can be sampled, which may amount to sampling from the assumed distributions with the modified values for hyper-parameters due to conjugacy. In some embodiments, the expected value of the profit-per-view can be derived by integrating out the sᵢ and cᵢ, e.g.,

$$E ( {m}_{i} \vert r , π , \{ {μ}_{k} , {ρ}_{k} \} {κ}_{k = 1} ) = r {\sum }_{k} {π}_{k} {μ}_{k} .$$

In some other embodiments, a more complex function of the underlying distribution can be used.

Table 3 provides an exemplary pseudo code computer implemented process to determine a resultant webpage layout in accordance with an embodiment of the present disclosure.

TABLE 3
Given layouts 1, . . . , L, the previous section describes a set of 7 hyper
parameters we maintain for each layout (α, β, γ, m, s, ν, κ, where bold
notation denotes a vector of length K). As new sufficient statistics come in
from each layout users, these parameters are updated as in Eqs. 4-10. In
order to change the proportions of users seeing each layout, we perform the
following procedure:

| | |
|---|---|
| 1. | Initialize a vector C of size L with zeros. |
| 2. | For each layout l |
| | Sample r from a beta, π from a Dirichlet, and μₖ from the Normal |
| | inverse-gamma using the current hyper-parameters to perform the |
| | sampling. These probability distributions are implemented in |
| | numpy.random. |
| | Specifically given the following python implementations: |
| | $\begin{matrix}ρ \sim gamma ( k , θ ) , & p ( ρ ) = {ρ}^{k - 1} \frac{{e}^{- ρ / θ}}{{θ}^{k} Γ ( k )} \\ μ \sim normal ( m , σ ) , & p ( μ ) = \frac{1}{\sqrt{2 {πσ}^{2}}} {e}^{- \frac{{( μ - m )}^{2}}{2 {σ}^{2}}}\end{matrix}$ |
| | $and the hyper \text{-} parameters m , s , v , κ , use k = \frac{v}{2} , θ = \frac{2}{s} , σ = \sqrt{\frac{1}{κρ}}$ |
| | Compute the expected E (mᵢ^{l}) value for each layout l using Eq. 19 |
| 3. | Compare all E (mᵢ¹), . . . , E (mᵢ^{L}) and pick the largest. Let that be l |
| 4. | add 1 to Cₗ |
| 5. | repeat steps 2-4 many times (100K), and normalize C by that. This |
| | vector represents the proportions of users that should see each view. |

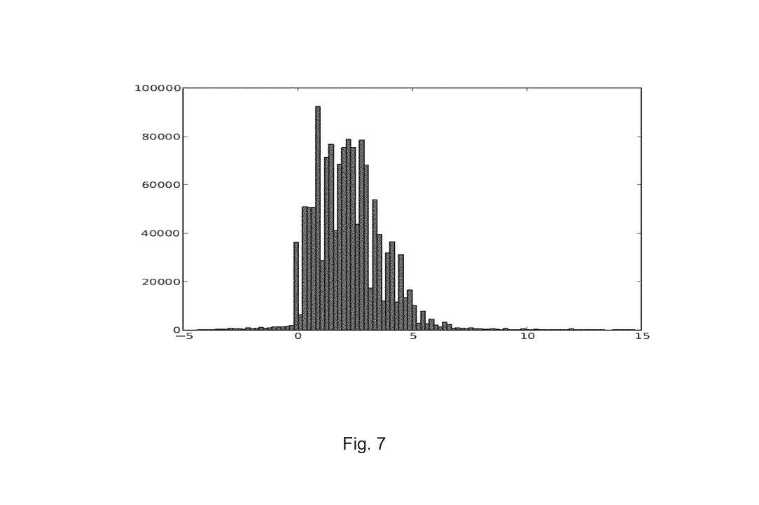

FIG. 7 is a data plot illustrating empirical data that supports the Gaussian mixture modeling assumption that used in accordance with an embodiment of the present disclosure. As demonstrated the data plot is similar to a Gaussian function and so the display distribution can be regarded as a similar Gaussian function, as explained in greater detail above.

With respect to the data collection process, the basic event can be a visitor's view-event. Each view can be associated with a purchase/non-purchase information, and, when a purchase occurs, the profit information, and the category information. In some embodiments, the statistics N, S, Sₖ, Sₖ, Pₖ² used for updating the parameters can be passed computed and passed along at every pre-determined time internal.

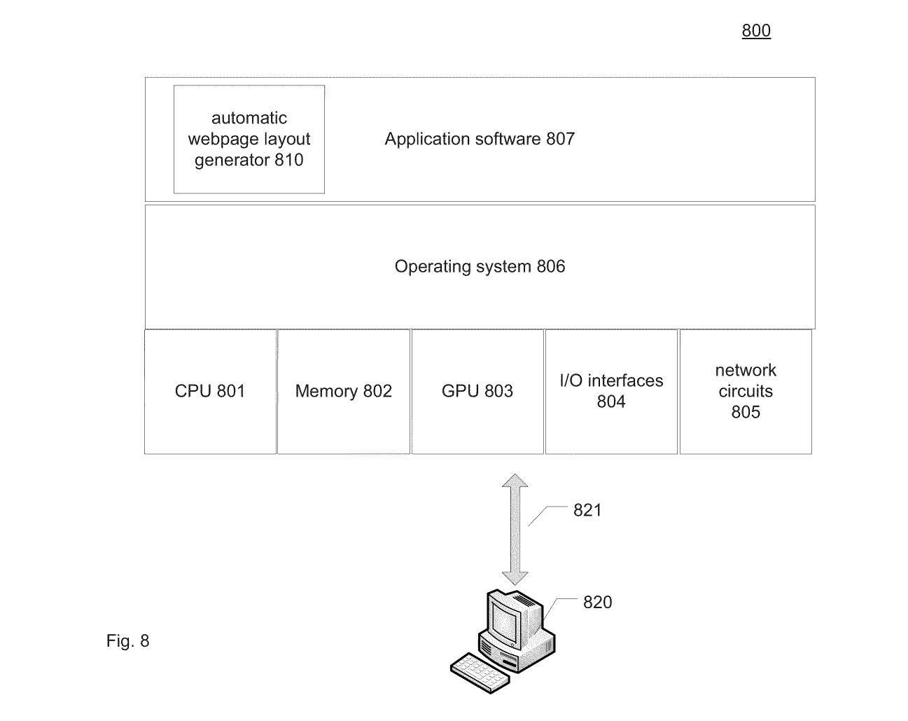

FIG. 8 is a block diagram illustrating an exemplary computing system 800 including an automatic webpage layout generator 800 in accordance with an embodiment of the present disclosure. The computing system 800 comprises a processor 801, a system memory 802, a GPU 803, I/O interfaces 804 and network circuits 805, an operating system 806 and application software 807 including the automatic webpage layout generator 800 stored in the memory 802. The computing system 800 is connected with a remote client computer 820 that has web browser or alike through a communication network 821. When incorporating the user's configuration input and executed by the CPU 801, the automatic webpage layout generator 800 can automatically generate layout variants, select webpages to be displayed at a remote client display device 820 in different layouts based on profit performances thereof, and discover an optimized layout empirically in accordance with an embodiment of the present disclosure. The automatic webpage layout generator 800 may perform various functions and processes as discussed in detail with reference to FIG. 1-7. As will be appreciated by those with ordinary skill in the art, the automatic webpage layout generator 800 can be implemented in any one or more suitable programming languages that are known to those skilled in the art, such as C, C++, Java, Python, Perl, C#, SQL, etc.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A computer implemented method of automatically determining a webpage layout, said method comprising:
accessing a set of test webpage layouts;
selecting for display said set of test webpage layouts to visitors to a website in accordance with a display probability distribution thereof, wherein each test webpage layout is assigned with a respective display probability value within said distribution;
evaluating said set of test webpage layouts based on profit associated with purchase activities based on commodities associated with said set of test webpage layouts;
adjusting said display probability distribution based on said evaluating;
repeating said selecting and said evaluating; and
selecting a resultant webpage layout from said test webpage layouts based on said evaluation.

2. The computer implemented method of claim 1, wherein said evaluating comprises determining expected profit rates of said set of test webpage layouts based on a determination that a profit rate is normally distributed, and wherein further said adjusting comprises adjusting said display probability distribution based on a distribution of said expected profit rates over said set of test webpage layouts.

3. The computer implemented method of claim 2, wherein said determining comprises updating hyper-parameters of a respective normal distribution based on observed profit values associated with a respective test webpage layout, and wherein an expected profit rate of said respective test webpage layout corresponds to a mean of said observed profit values.

4. The computer implemented method of claim 3, wherein said observed profit values are computed based on view-events resulting in purchases.

5. The computer implemented method of claim 3, wherein said expected profit rate of said respective test webpage layout is derived by a weighted integration of K components of profit rates in accordance with a multinomial distribution, wherein K represents a number of commodity categories presented through said respective test webpage layout, and wherein each of said K components correspond to a respective Gaussian distribution.

6. The computer implemented method of claim 2, wherein said determining comprises determining an expected profit rate of a respective test webpage layout, wherein said expected profit rate is determined based on a conversion rate and observed profit values related to said respective test webpage layout.

7. The computer implemented method of claim 6, wherein said expected profit rate is computed by a combination of a zero-profit component and a normally distributed component, wherein each component comprises a respective probability value related to said conversion rate, wherein said zero-profit component corresponds to view-events with no purchases, and wherein said normally distributed component corresponds to purchase events with purchases.

8. The computer implemented method of claim 7, wherein said expected profit rate of said respective test webpage layout is derived by a weighted integration of K components of profit rates in accordance with a multinomial distribution, wherein K represents a number of commodity categories presented through said respective test webpage layout, and wherein each of said K components correspond to a respective normal distribution with a respective set of hyper-parameters.

9. The computer implemented method of claim 7, wherein a respective set of hyper parameters corresponding to each of said K components are updated in a predefined order based on a total number of purchases, a total number of purchases per category, a sum of all profit per category, and a sum of all squared profit per category.

10. The computer implemented method of claim 1, wherein said set of test webpage layouts are displayed with contests, offers, e-readers on sale, and book-content for different lengths of time.

11. A non-transitory computer-readable storage medium embodying instructions that, when executed by a processing device, cause the processing device to perform a method of determining a profit rate of a webpage layout, said method comprising:
selecting for displaying said webpage layout to visitors to a website with content comprising commodities in N view events, wherein N is an integer;
determining a conversion rate r of said webpage layout;
determining a respective profit mᵢ resulted from each view-event, wherein i=1, 2, . . . , N;
deriving a profit rate distribution p from a zero-profit component and a normally distributed component, wherein each component comprises a respective probability value related to said conversion rate, wherein said zero-profit component corresponds to view-events resulting in no purchases, and wherein said normally distributed component corresponds to view events resulting in purchases; and
deriving a profit rate of said webpage layout based on said profit rate distribution.

12. The non-transitory computer-readable storage medium of claim 11, wherein observed profits related to said webpage layout comprise K profit categories, wherein K is an integer, and wherein said method further comprises:
determining respective category weights of said K profit categories in accordance with a multinomial distribution based on said observed profits, wherein each profit category is assumed to have a respective normal distribution; and
updating hyper-parameters of a respective normal distribution for each profit category based on a total number of purchases, a total number of purchases per category, a sum of all profit per category, and a sum of all squared profit per category.

13. The non-transitory computer-readable storage medium of claim 11, wherein said conversion rate is determined in accordance with a Beta-Bernoulli model, and wherein said profit rate corresponds to an expected value of a profit-per-view.

14. The non-transitory computer-readable storage medium of claim 11, wherein said determining a respective profit mᵢ comprises:
sampling a variable sᵢ from said conversion rate to determine whether or not to purchase;
sampling said respective profit mᵢ from a normal distribution if a purchase is resulted from a view event; and
setting said respective profit mᵢ to be zero if no purchase is resulted from a view event.

15. A system comprising:
a processor;
a network circuit; and
a memory coupled to said processor and comprising instructions that, when executed by said processor, automatically determine a webpage layout for a website, said method comprising:
accessing a set of test layouts;
selecting for display said set of test layouts to visitors to said website in accordance with a display probability distribution, wherein each test layout is assigned with a respective display probability value within said distribution;
evaluating said set of test layouts based on profit associated with commodities presented in said set of test layouts;
adjusting said display probability distribution based on said evaluating;
repeating said displaying and said evaluating; and
selecting a resultant layout from said test layouts based on said evaluating for subsequent displays.

16. The system of claim 15, wherein said evaluating comprises determining expected profit rates of said set of test layout based on a determination that a profit rate is normally distributed, and wherein further said display probability distribution is adjusted based on a distribution of said expected profit rates over said set of test layouts.

17. The system of claim 16, wherein said determining comprises updating hyper-parameters of a respective normal distribution based on observed profit values associated with a respective test layout, and wherein an expected profit rate of said respective test layout corresponds to a mean of said observed profit values.

18. The system of claim 17, wherein said expected profit rate of said respective test layout is derived by a weighted integration of K components of profit rates in accordance with a multinomial distribution, wherein K represents a number of commodity categories presented through said respective test layout, and wherein each of said K components correspond to a respective Gaussian distribution.

19. The system of claim 15, wherein said determining comprises determining an expected profit rate of a respective test layout, wherein said expected profit rate is determined based on a conversion rate and observed profit values related to said respective test layout.

20. The system of claim 19, wherein said expected profit rate is computed by a combination of a zero-profit component and a normally distributed component, wherein each component comprises a respective probability value related to said conversion rate, wherein said zero-profit component corresponds to view-events with no purchases, and wherein said normally distributed component corresponds to purchase events with purchases.
